(19) United States
(12) Patent Application Publication
(10) Pub. No.: US 2008/0219755 A1
(43) Pub. Date: Sep. 11, 2008

(54) SEAT POST ADJUSTMENT APPARATUS

(76) Inventor: Ohannes Meguerditchian, Glendale, CA (US)

Correspondence Address: ITALIA IP, 3500 WEST OLIVE AVE., SUITE 300, BURBANK, CA, 91505, US

(21) Appl. No.: 11/683,432

(22) Filed: Mar. 7, 2007

(51) Int. Cl. F16C 11/00

(52) U.S. Cl. 403/84; 297/215.13

(57) ABSTRACT

A seat post adjustment apparatus for adjusting the angle between a seat post portion and a frame portion, said apparatus comprising first and second sleeve portions each including pivot means at one end, wherein one pivot means pivotably attaches to said seat post portion and the other pivotably attaches to said frame portion; seat post adjustment means functionally linked to said first and second sleeve portions for increasing or decreasing the angle between said seat post portion and said frame portion wherein said seat post portion includes a pivot point; and locking means functionally linked to said first and second sleeve portions for locking the apparatus at the desired angle.

### BACKGROUND OF INVENTION

This application relates generally to a seat post adjustment apparatus. More specifically, this application discloses seat post adjustment apparatus that allows a user of to adjust the angle between a seat post portion and a frame portion located on a bike or other peddled device.

### SUMMARY

This application discloses a seat post adjustment apparatus for adjusting the angle between a seat post portion and a frame portion. The apparatus is of simple construction and can be used in a variety of applications including in standard bicycles, tricycles, reclining or rectilinear bicycles. The apparatus is especially beneficial in that it allows a user to convert a peddled device such as a bike from a standard bicycle seat position to a semi-rectilinear bicycle seat position.

In particular, this application discloses a seat post adjustment apparatus for adjusting the angle between a seat post portion and a frame portion, said apparatus comprising first and second sleeve portions each including pivot means at one end, wherein one pivot means pivotably attaches to said seat post portion and the other pivotably attaches to said frame portion; seat post adjustment means functionally linked to said first and second sleeve portions for increasing or decreasing the angle between said seat post portion and said frame portion wherein said seat post portion includes a seat post frame pivot point at its attachment to said frame portion; and locking means functionally linked to said first and second sleeve portions for locking the apparatus at the desired angle.

This application also discloses a seat post adjustment apparatus for adjusting the angle between a seat post portion and a frame portion, said apparatus comprising: first and second sleeve portions each including pivot means at one end, wherein one pivot means pivotably attaches to said seat post portion and the other pivotably attaches to said frame portion; seat post adjustment means functionally linked to said first and second sleeve portions for increasing or decreasing the angle between said seat post portion and said frame portion wherein said seat post portion includes a seat post frame pivot point at its attachment to said frame portion; locking means functionally linked to said first and second sleeve portions for locking the apparatus at the desired angle; and shock absorbing means functionally linked to said first and second sleeve portions for absorbing vibration created between said seat post portion and said frame portion.

This application further discloses an improved adjustable bicycle apparatus of the type wherein bicycle pedals are driven by the feet of a rider seated upon a seat mounted to a seat post, wherein the seat post is mounted to a frame portion, and wherein handle bars mounted upon a handle bar shaft and held in a handle bar post are used to steer the bike, the improvement comprising first and second sleeve portions each including pivot means at one end, wherein one pivot means pivotably attaches to said seat post portion and the other pivotably attaches to said frame portion; seat post adjustment means functionally linked to said first and second sleeve portions for increasing or decreasing the angle between said seat post portion and said frame portion wherein said seat post portion includes a seat post frame pivot point at its attachment to said frame portion; locking means functionally linked to said first and second sleeve portions for locking the apparatus at the desired angle; handle bar shaft adjustment means functionally linked to said handle bar shaft for extending the handle bars toward or away from said rider; handle bar post adjustment means functionally linked to said handle bar for extending the handle bar post in an out of the handle bar post; and wherein the seat adjustment means allows for the positioning of the seat post about a radial axis defining a maximum and minimum horizontal position, and whereby the seat post further comprises seat telescoping means for allowing a seat to be raised or lowered thereby defining a minimum and maximum vertical position mount, such that a seat can be spatially located at any position between said minimum and maximum horizontal and vertical positions.

### BRIEF DESCRIPTION OF THE DRAWINGS

The drawings, when considered in connection with the following description, are presented for the purpose of facilitating an understanding of the subject matter sought to be protected.

FIG. 1 is side plan view of a second embodiment of the seat post adjustment apparatus disclosed herein incorporated on a bicycle;

FIG. 2A is an enlarged, fragmentary view of a first embodiment of the seat post adjustment apparatus disclosed herein incorporated on a bicycle shown in a semi-rectilinear position;

FIG. 2B is an enlarged, fragmentary view of a first embodiment of the seat post adjustment apparatus disclosed herein incorporated on a bicycle shown in an upright;

FIG. 3A is an enlarged, fragmentary, cross-section view of the seat post adjustment apparatus in FIG. 2A;

FIG. 3B is an enlarged, fragmentary, cross-section view of the seat post adjustment apparatus in FIG. 2B;

FIG. 4A is an enlarged, fragmentary view of a second embodiment of the seat post adjustment apparatus as disclosed herein incorporated on a bicycle shown in a semi-rectilinear position;

FIG. 4B is an enlarged, fragmentary view of a second embodiment of the seat post adjustment apparatus disclosed herein incorporated on a bicycle shown in an upright;

FIG. 5A is an enlarged, fragmentary, cross-section view of the seat post adjustment apparatus in FIG. 4A;

FIG. 5B is an enlarged, fragmentary, cross-section view of the seat post adjustment apparatus in FIG. 4B;

FIG. 6 is side plan view of a fourth embodiment of the seat post adjustment apparatus disclosed herein incorporated on a bicycle;

FIG. 7A is an enlarged, fragmentary view of a third embodiment of the seat post adjustment apparatus disclosed herein incorporated on a bicycle shown in a semi-rectilinear position;

FIG. 7B is an enlarged, fragmentary view of third embodiment of the seat post adjustment apparatus disclosed herein incorporated on a bicycle shown in an upright;

FIG. 8A is an enlarged, fragmentary, cross-section view of the seat post adjustment apparatus in FIG. 7A;

FIG. 8B is an enlarged, fragmentary, cross-section view of the seat post adjustment apparatus in FIG. 7B;

FIG. 9A is an enlarged, fragmentary view of a fourth embodiment of the seat post adjustment apparatus as disclosed herein incorporated on a bicycle shown in a semi-rectilinear position;

FIG. 9B is an enlarged, fragmentary view of a fourth embodiment of the seat post adjustment apparatus disclosed herein incorporated on a bicycle shown in an upright;

FIG. 10A is an enlarged, fragmentary, cross-section view of the seat post adjustment apparatus in FIG. 9A; and

FIG. 10B is an enlarged, fragmentary, cross-section view of the seat post adjustment apparatus in FIG. 9B.

### DETAILED DESCRIPTION

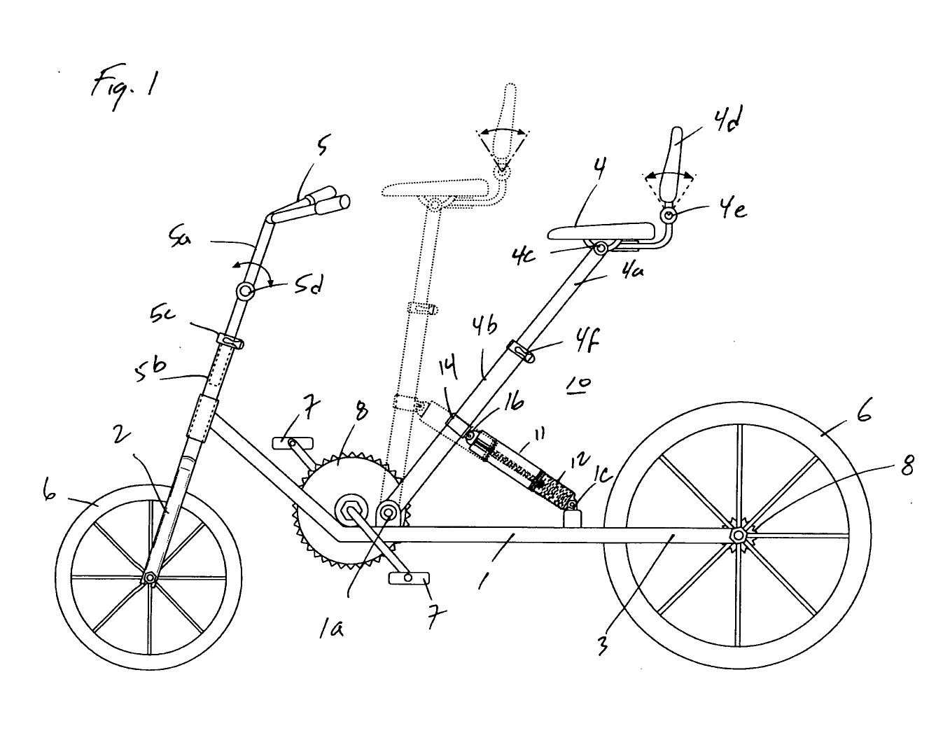

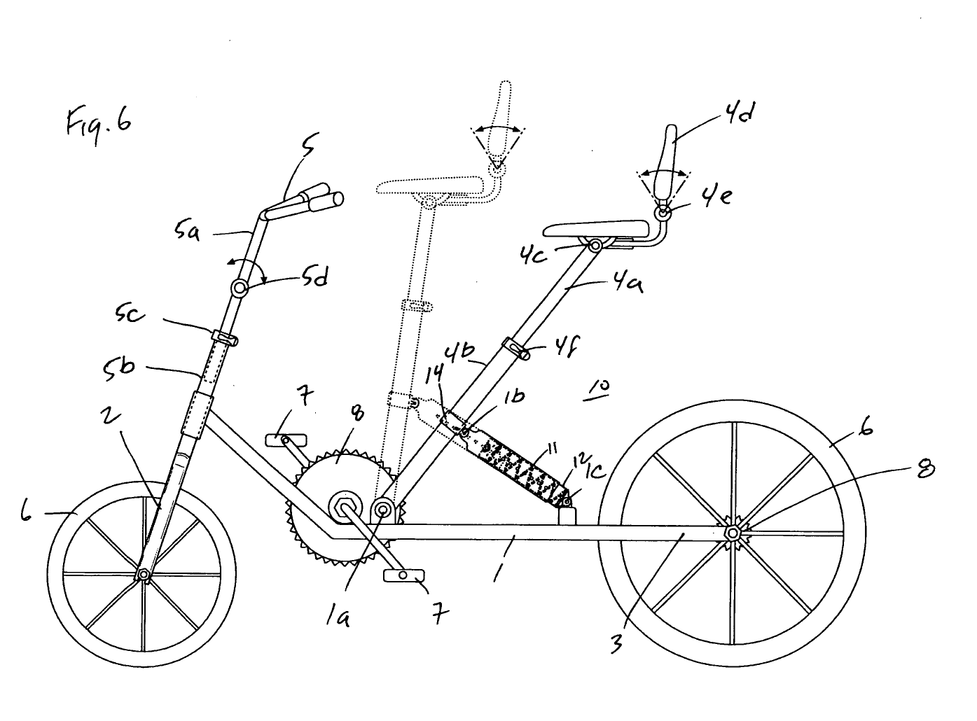

Referring to FIGS. 1 and 6, and shown therein and generally designated by the reference character 10 is the second and fourth embodiment respectively of the seat post adjustment apparatus 10 constructed in accordance with the following description. For simplification of the following description, the various embodiments of the seat post adjustment apparatus herein can be generally described as falling into either a thread rod assembly or a pin and bore assembly. The first and second embodiment of the seat post adjustment apparatus 10 is an example of a threaded rod assembly and the third and fourth embodiment is an example of a pin and bore assembly. Each of the four embodiments are shown incorporated in a bicycle; however, it should be appreciated that the seat post adjustment apparatus may be incorporated in a tricycle or any other similar transportation device that utilizes a rider's “peddling” motion to propel the transportation device in a desired direction. Regardless of the nature of the transportation device, which are well known in the art, and shown for example purposes only, each is generally characterized by having a frame 1 that includes a front forks 2, rear forks 3, a seat 4 mounted to a seat shaft 4a and retained within a seat post 4b, handle bars 5 mounted to a handle bar shaft 5a and retained within a handle bar post 5b, wheels 6, pedals 7, drive sprockets 8, and a chain linking the drive sprockets (not shown). FIGS. 1 and 6. In addition to the general characteristics of the bike shown in FIGS. 1 and 6, the frame 1 includes a seat post frame pivot point 1a that links the seat post 4b to the frame portion 1. Further, the seat post includes a pivot point 1b that links the seat post adjustment apparatus 10 to the seat post 4b and pivot point 1c that links the seat post adjustment apparatus 10 to the frame 1. FIGS. 1 and 6.

The handle bars 5 include handle bar adjustment means that allow for the handle bar shaft 5a to be set at the desired distance within the handle bar post 5b. Such means are common in the art and in the embodiments shown, a crimping clip 5c is shown as an example, however, other means that are common in the art, or are yet to be discovered, are contemplated as being included as part of this disclosure. The handle bar shaft 5a may also include handle bar shaft adjustment means that allow the linked handle bars 5 to be extended toward or away from a given rider. Again, such means are common in the art and in the embodiments shown, a lockable pivot 5d is shown as an example, however, other means that are common in the art, or are yet to be discovered, are contemplated as being included as part of this disclosure. FIGS. 1 and 6.

The seat 4 may also include adjustment means. For example a lockable seat pivot 4c is included where the seat 4 attaches to the seat shaft 4a. And if the seat 4 includes a back portion 4d (as shown), and lockable seat back pivot 4e can used. Such seat adjustment means are common in the art, however, other means that are common in the art, or are yet to be discovered, are contemplated as being included as part of this disclosure. The seat 4 and attached seat shaft 4a includes adjustment means that allow for the seat shaft 4a to be set at the desired distance within the seat post 4b. Such means are common in the art and in the embodiments shown, a crimping clip 4f is shown as an example, however, other means that are common in the art, or are yet to be discovered, are contemplated as being included as part of this disclosure. FIGS. 1 and 6.

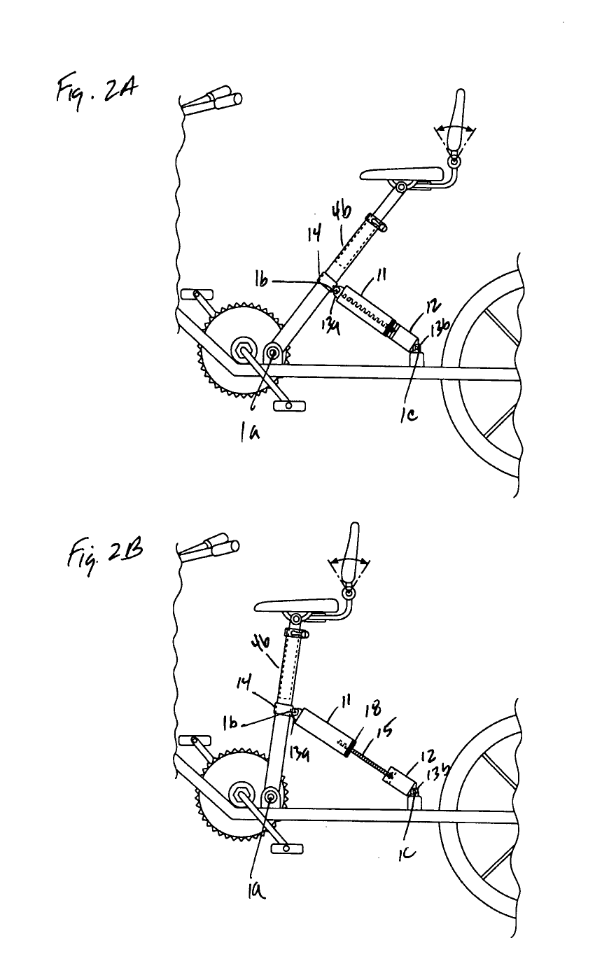

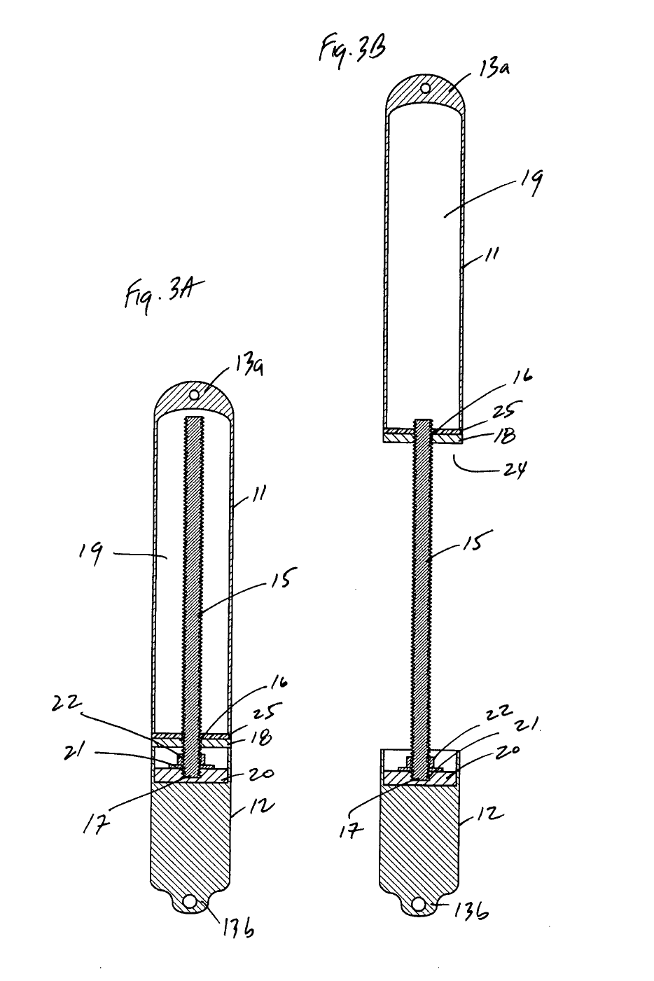

Referring now to FIGS. 2A-3B, a first embodiment of the seat post adjustment apparatus is shown wherein the adjustment means is a threaded rod assembly. The threaded rod assembly includes a first sleeve portion 11 and a second sleeve portion 12 linked by a threaded rod 15. Each sleeve includes a pivot point at each end. The first sleeve portion pivot point 13a is attached to a seat post pivot point 1b which is attached to the seat post 4b by a retaining band 14. The second sleeve pivot point 13b is attached to the pivot point 1c. The pivots 13 shown by way of example are common in the art. The threaded rod 15 includes a portion 16 that is threadably received by the first sleeve portion 11 and a portion at the opposite end 17 of the threaded rod 15 for the engagement to the second sleeve portion 12. The threaded rod 15 is received by the first sleeve portion 11 by adjusting means such as a mateably threaded knob 18. The knob 18 is attached to the open portion 24 of the first sleeve portion by means of a washer 25 that allows the knob 18 to rotate about the threaded rod 15. Further, the washer 25 may include locking means as is known in the art whereby when the knob 18 and first sleeve 11 is engaged with the washer 25, the knob 18 is prevented from rotating. The threaded rod 15 is engaged to the second sleeve portion 12 by attachment to a plate 20 that is fixedly attached to the second sleeve portion 12. In the embodiment provided, the plate 20 includes a threaded bore 21 to receive a portion of the threaded rod 15. A locking nut 22 is then screwed in place to retain the threaded rod 15 in the threaded bore 21 of the plate 20. FIGS. 3A and 3B.

When the knob 18 is turned in a given direction, the first sleeve 11 moves up and down the threaded rod 15 relative to the second sleeve 12 such that the seat post 4b is pivoted about the seat post pivot point 1a. The first sleeve portion 11 is of sufficient length so as to take up the length of the threaded rod 15 in the area 19 above the knob 16 when the seat post 4b is in a substantially semi-rectilinear position as shown FIG. 2A. FIG. 2B shows how the apparatus 10 is used to create a bicycle where the seat post 4b is in a more upright position.

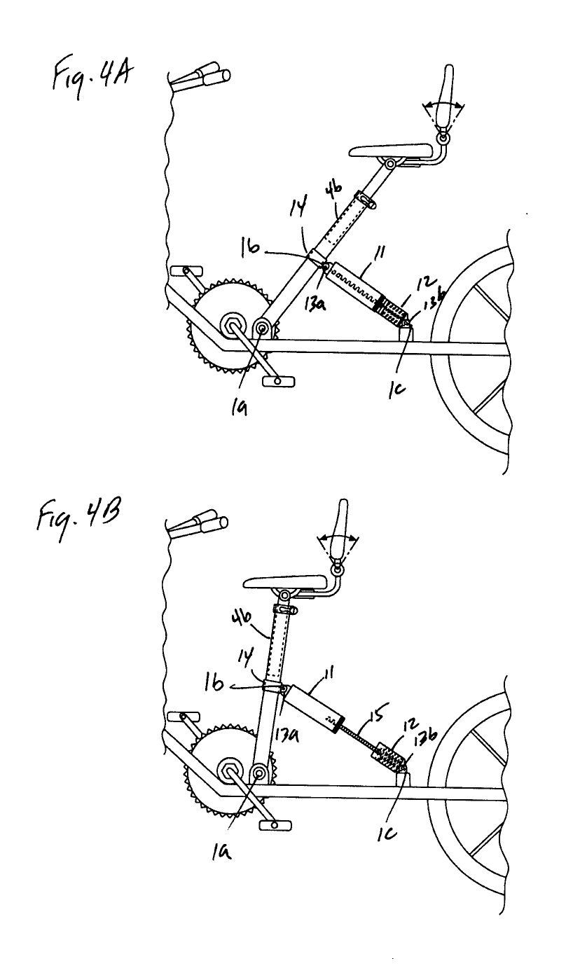

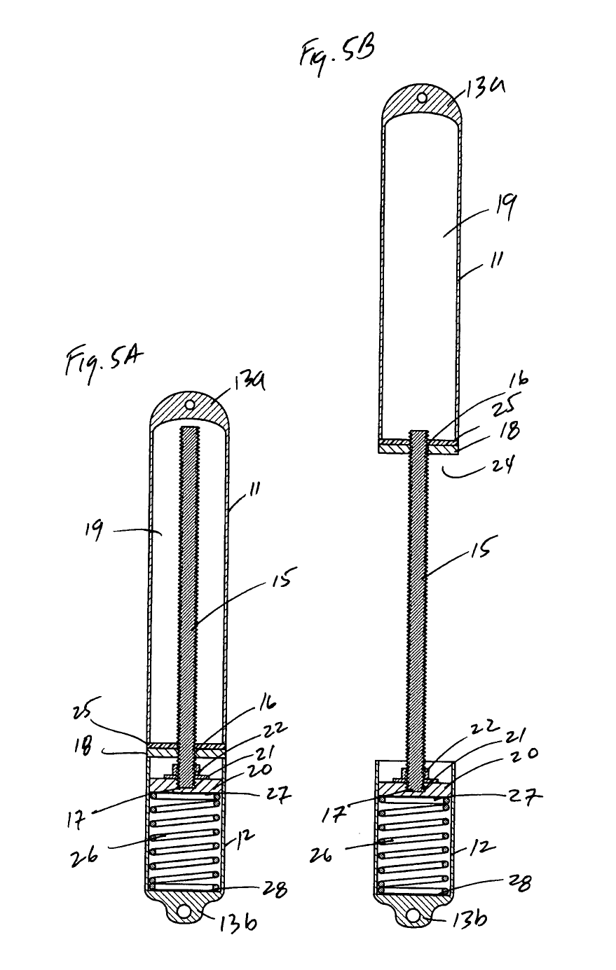

Referring now to FIGS. 4A-5B, a second embodiment of the seat post adjustment apparatus 10 is shown wherein the adjustment means is a threaded rod assembly as described above, and wherein the apparatus includes a shock absorbing assembly for absorbing vibration created between the seat post 4b and frame portion 1. The shock absorbing assembly includes a spring 26 that is fixedly attached at one end 27 to the threaded rod 15 by means of attaching it to the plate 20 and to the second sleeve portion 12 at the other end 28. The attachment of the spring 26 to the threaded rod 15 and second sleeve portion is done by welding small portions together, but may be by other means presently known in the art or later discovered. In addition, other dampening means may be used instead of the spring 26, including, but not limited to, gas shocks and other like devices. As described, shock absorbing assembly functionally links the first 11 and second sleeve 12 portions together.

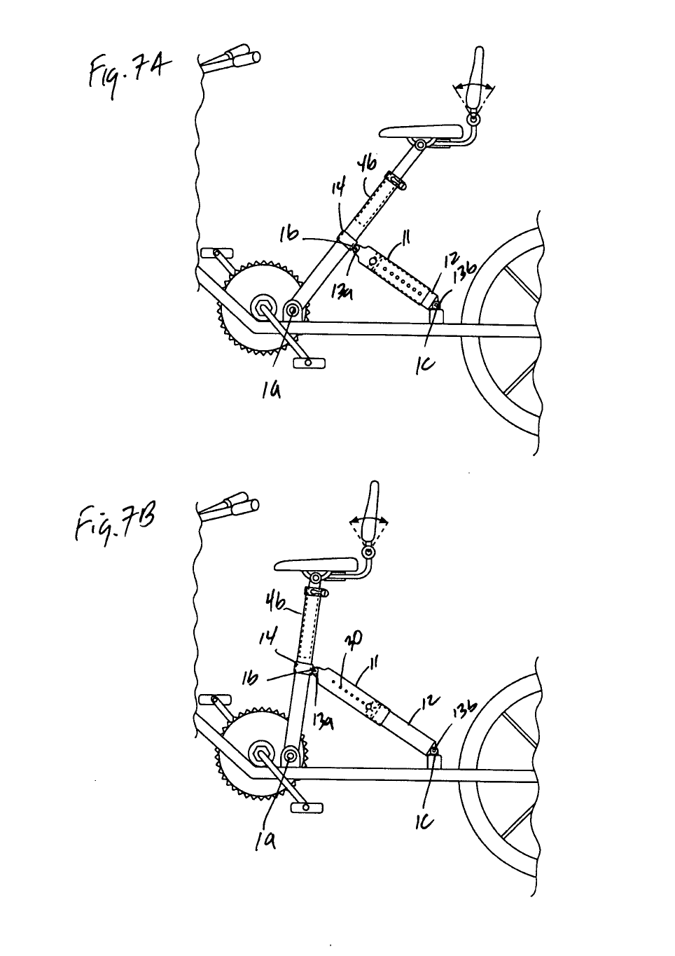

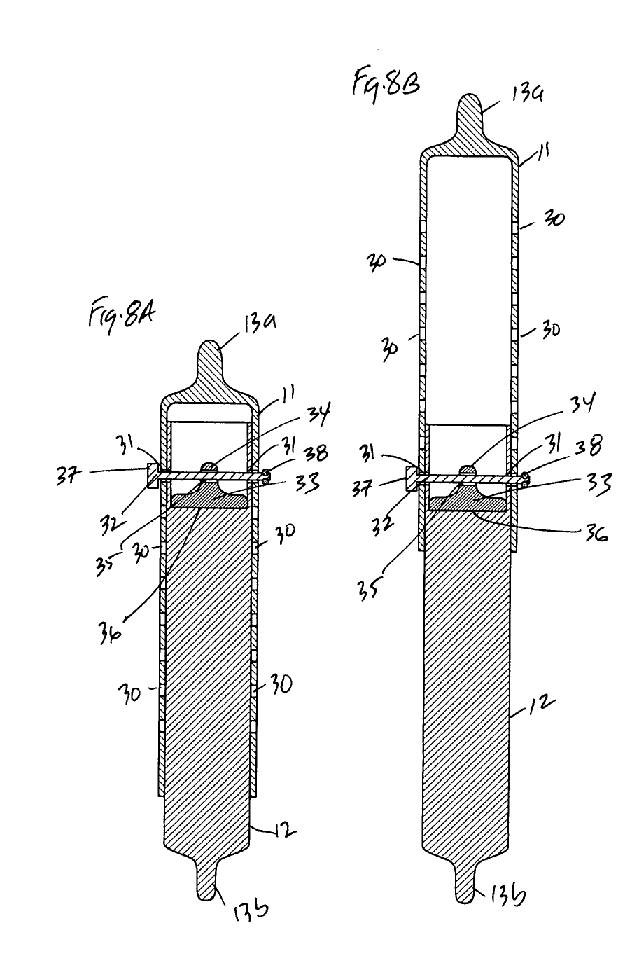

Referring now to FIGS. 7A-8B, a third embodiment of the seat post adjustment apparatus is shown wherein the adjustment means is a pin and bore assembly. As with the threaded rod assembly described above, the bin and bore assembly includes a first sleeve portion 11 and a second sleeve portion 12. Each sleeve includes a pivot point at each end. The first sleeve portion pivot point 13a is attached to a seat post pivot point 1b which is attached to the seat post 4b by a retaining band 14. The second sleeve pivot point 13b is attached to the pivot point 1a. Again, the pivots 13 shown by way of example are common in the art.

In this third embodiment the first sleeve portion 11 includes a series of bores 30 on opposite sides and the first sleeve portion 11 is of a larger diameter than the second sleeve portion 12, such that the first sleeve portion 11 is able to slideably move about the perimeter of the second sleeve thereby providing a telescoping adjustment means. The second sleeve portion 12 includes at least a pair of bores 31 on each side such that a pin 32 can be placed through the bores 30 in the first sleeve 11 and the bores 31 in the second sleeve 12 to hold the sleeve portions together at the desired angle of the seat post 4b and thereby provide a locking means. Alternatively, locking means may also include a sleeve engagement cap 33 that includes pin engagement portion 34 at one end, wherein the pin engagement portion is a bore 35, and second sleeve engagement portion 36 at the other such that the pin 32 can be placed through the bores 30 and 31 in the first 11 and second 12 sleeves, through the bore 35 in the sleeve engagement cap 33, and then through the bores 31 and 30 of the second 12 and first 11 sleeve portions on the opposite side. The pin 32 may include a gripping portion 37 and a spring activated locking mechanism 38 as is common in the art to hold the pin 32 in place. FIGS. 8A and 8B.

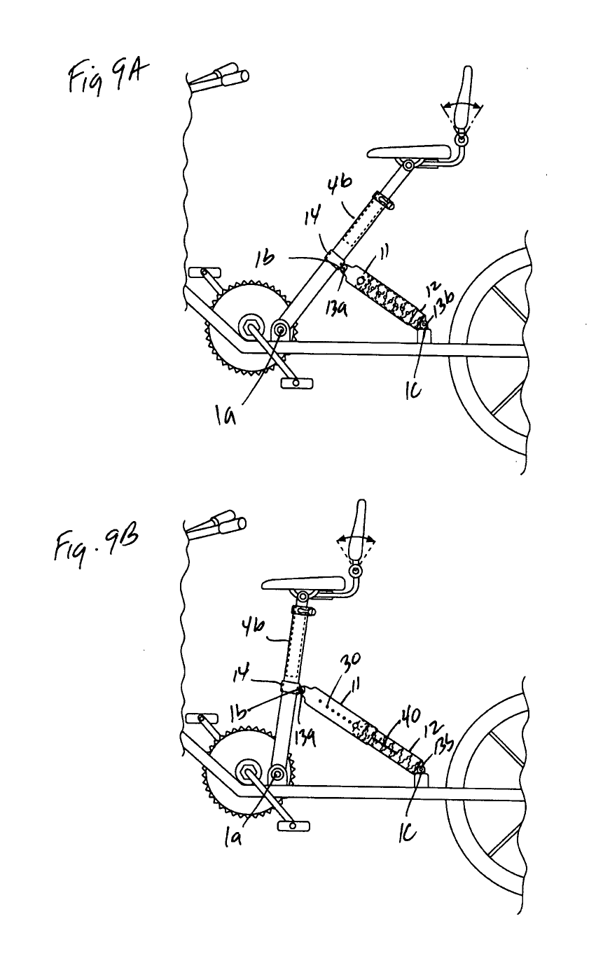

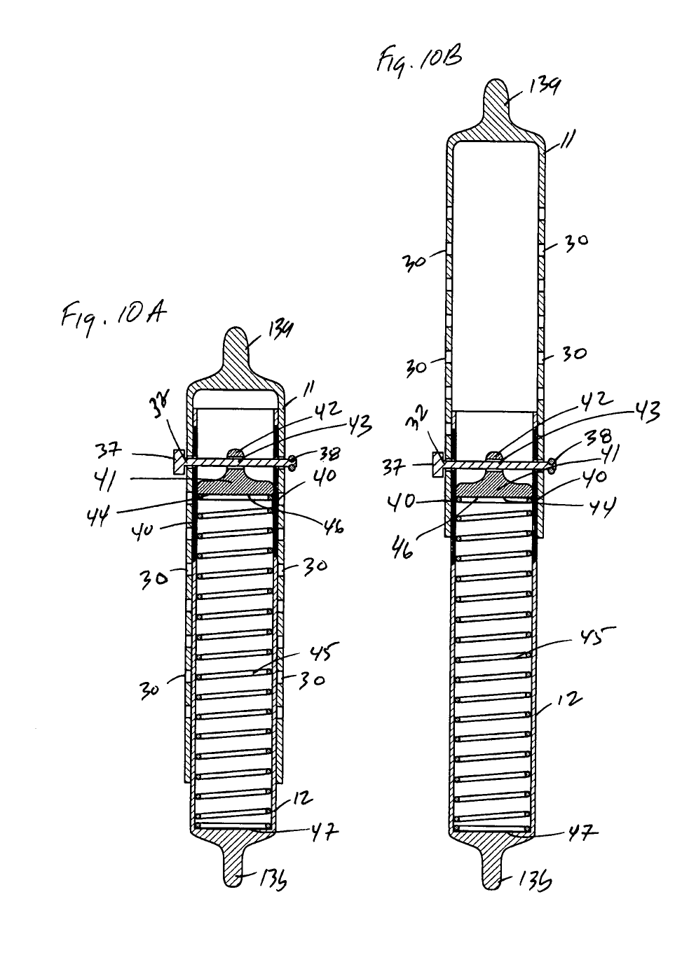

Referring now to FIGS. 9A-10B, a fourth embodiment of the seat post adjustment apparatus 10 is shown wherein the adjustment means is a pin and bore assembly as described above, and wherein the apparatus includes a shock absorbing assembly for absorbing vibration created between the seat post 4b and frame portion 1. In this embodiment the first sleeve portion 11 again includes a series of bores 30 on opposite sides; however, in this embodiment the second sleeve portion 12 includes a pair of channels 40. In this embodiment, the locking mechanism includes a spring engagement cap 41 that includes pin engagement portion 42 at one end, wherein the pin engagement portion 42 is a bore 43, and spring engagement portion 44 at the other such that a pin 32 can be placed through the bore 30 in the first sleeve 11, through the channel 40 in the second sleeve 12, through the bore 43 in the spring engagement cap 41, and then through channel 40 in the second sleeve 12 and the bore 30 of the first sleeve on the opposite side.

In this embodiment the shock absorbing means is a spring 45 that is fixedly attached at one end 46 to the spring engagement cap 41 and to the second sleeve portion 12 at the other 47. The attachment of the spring 45 to the spring engagement cap 41 and second sleeve portion 12 is done by welding small portions together, but may be by other means presently known in the art or later discovered. In addition, other dampening means may be used instead of the spring 45, including, but not limited to, gas shocks and other like devices. As described, shock absorbing assembly functionally links the first 11 and second sleeve 12 portions together.

As shown in each of the above described embodiments, the seat post adjustment apparatus 10 allows for the positioning of the seat post 4b about a radial axis defining a maximum and minimum horizontal position, and whereby the seat post 4b, when associated with the telescoping adjustment means of the seat 4 attached to the seat shaft 4a which allows the seat 4 to be raised or lowered thereby defining a minimum and maximum vertical position mount, a seat can be spatially located at any position between said minimum and maximum horizontal and vertical positions.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A seat post adjustment apparatus for adjusting the angle between a seat post portion and a frame portion, said apparatus comprising:
first and second sleeve portions each including pivot means at one end, wherein one pivot means pivotably attaches to said seat post portion and the other pivotably attaches to said frame portion;
seat post adjustment means functionally linked to said first and second sleeve portions for increasing or decreasing the angle between said seat post portion and said frame portion wherein said seat post portion includes a seat post frame pivot point at its attachment to said frame portion; and
locking means functionally linked to said first and second sleeve portions for locking the apparatus at the desired angle.

2. The apparatus of claim 1 wherein the adjustment means is a threaded rod assembly including a threaded rod wherein the threaded rod includes a portion that is threadably received by the first sleeve portion, which includes means to adjust the first sleeve portion about the threaded rod and an area to receive the threaded rod, and a portion at the opposite end of the threaded rod for the engagement to the second sleeve portion.

3. The apparatus of claim 2 wherein the means to adjust the first sleeve portion about the threaded rod is a knob attached to said first sleeve, such that when the knob is turned in a given direction, the first sleeve moves up and down the threaded rod relative to the second sleeve.

4. The apparatus of claim 3 wherein said locking means includes a washer functionally linked to said knob and first sleeve portion such that when the knob is engaged with said washer, the knob is prevented from rotating.

5. The apparatus of claim 2 wherein the adjustment means allows for the positioning of the seat post about a radial axis defining a maximum and minimum horizontal position, and whereby the seat post further comprises seat telescoping means for allowing a seat to be raised or lowered thereby defining a minimum and maximum vertical position mount, such that a seat can be spatially located at any position between said minimum and maximum horizontal and vertical positions.

6. The apparatus of claim 1 wherein the adjustment means is a telescoping assembly wherein the first sleeve is of a larger diameter than the second sleeve, such that the first sleeve is able to slideably move about the perimeter of the second sleeve.

7. The apparatus of claim 6 wherein said locking means includes a pin and bore assembly wherein the first sleeve includes a series of bores on opposite sides, and the second sleeve includes a least a pair of bores on each side such that a pin can be placed there through to hold the sleeves together at the desired angle.

8. The apparatus in claim 7 wherein said locking means further comprises a sleeve engagement cap that includes pin engagement portion at one end, where in the pin engagement portion is a bore, and second sleeve engagement portion at the other such that a pin can be placed through the bores in the first and second sleeves, through the bore in the sleeve engagement cap, and then through the bores of the second and first sleeve on the opposite side.

9. The apparatus of claim 6 wherein the adjustment means allows for the positioning of the seat post about a radial axis defining a maximum and minimum horizontal position, and whereby the seat post further comprises seat telescoping means for allowing a seat to be raised or lowered thereby defining a minimum and maximum vertical position mount, such that a seat can be spatially located at any position between said minimum and maximum horizontal and vertical positions.

10. A seat post adjustment apparatus for adjusting the angle between a seat post portion and a frame portion, said apparatus comprising:
first and second sleeve portions each including pivot means at one end, wherein one pivot means pivotably attaches to said seat post portion and the other pivotably attaches to said frame portion;
seat post adjustment means functionally linked to said first and second sleeve portions for increasing or decreasing the angle between said seat post portion and said frame portion wherein said seat post portion includes a seat post frame pivot point at its attachment to said frame portion;
locking means functionally linked to said first and second sleeve portions for locking the apparatus at the desired angle; and
shock absorbing means functionally linked to said first and second sleeve portions for absorbing vibration created between said seat post and said frame portion.

11. The apparatus of claim 10 wherein the adjustment means is a threaded rod assembly including a threaded rod wherein the threaded rod includes a portion that is threadably received by the first sleeve portion, which includes means to adjust the first sleeve portion about the threaded rod and an area to receive the threaded rod, and a portion at the opposite end of the threaded rod for the engagement to the shock absorbing means.

12. The apparatus of claim 11 wherein the means to adjust the first sleeve portion about the threaded rod is a knob attached to said first sleeve, such that when the knob is turned in a given direction, the first sleeve moves up and down the threaded rod relative to the second sleeve.

13. The apparatus of claim 12 wherein said locking means includes a washer functionally linked to said knob and first sleeve portion such that when the knob is engaged with said washer, the knob is prevented from rotating.

14. The apparatus of claim 11 wherein the shock absorbing means is a spring that is fixedly attached at one end to the threaded rod and to the second sleeve portion at the other.

15. The apparatus of claim 10 wherein the adjustment means is a telescoping assembly wherein the first sleeve is of a larger diameter than the second sleeve, such that the first sleeve is able to slideably move about the perimeter of the second sleeve.

16. The apparatus of claim 15 wherein said locking means includes a pin and bore assembly wherein the first sleeve includes a series of bores, the second sleeve includes a pair of channels, and wherein the locking means further comprises a spring engagement cap that includes pin engagement portion at one end, wherein the pin engagement portion is a bore, and spring engagement portion at the other such that a pin can be placed through the bore in the first sleeve, through the channel in the second sleeve, through the bore in the spring engagement cap, and then through channel in the second sleeve and the bore of the first sleeve on the opposite side.

17. The apparatus of claim 16 wherein the shock absorbing means is a spring that is fixedly attached at one end to the spring engagement cap and to the second sleeve portion at the other.

18. The apparatus of claim 10 wherein the adjustment means allows for the positioning of the seat post about a radial axis defining a maximum and minimum horizontal position, and whereby the seat post further comprises seat telescoping means for allowing a seat to be raised or lowered thereby defining a minimum and maximum vertical position mount, such that a seat can be spatially located at any position between said minimum and maximum horizontal and vertical positions.

19. An improved adjustable bicycle apparatus of the type wherein bicycle pedals are driven by the feet of a rider seated upon a seat mounted to a seat post, wherein the seat post is mounted to a frame portion, and wherein handle bars mounted upon a handle bar shaft and held in a handle bar post are used to steer the bike, the improvement comprising:
first and second sleeve portions each including pivot means at one end, wherein one pivot means pivotably attaches to said seat post portion and the other pivotably attaches to said frame portion;
seat post adjustment means functionally linked to said first and second sleeve portions for increasing or decreasing the angle between said seat post portion and said frame portion wherein said seat post portion includes a seat post frame pivot point at its attachment to said frame portion;
locking means functionally linked to said first and second sleeve portions for locking the apparatus at the desired angle;
handle bar shaft adjustment means functionally linked to said handle bar shaft for extending the handle bars toward or away from said rider;
handle bar post adjustment means functionally linked to said handle bar for extending the handle bar shaft in an out of the handle bar post; and
wherein the seat adjustment means allows for the positioning of the seat post about a radial axis defining a maximum and minimum horizontal position, and whereby the seat post further comprises seat telescoping means for allowing a seat to be raised or lowered thereby defining a minimum and maximum vertical position mount, such that a seat can be spatially located at any position between said minimum and maximum horizontal and vertical positions.

20. The improved bicycle apparatus of claim 19 further comprising shock absorbing means functionally linked to said first and second sleeve portions for absorbing vibration created between said seat post portion and said frame portion.
